(19) United States
(12) Patent Application Publication
(10) Pub. No.: US 2011/0007013 A1
(43) Pub. Date: Jan. 13, 2011

(54) INPUT DEVICE AND INPUT FUNCTION-EQUIPPED DISPLAY DEVICE

(75) Inventor: Hinata Shoji, Nagano (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/829,007

(22) Filed: Jul. 1, 2010

(30) Foreign Application Priority Data
Jul. 8, 2009 (JP) P2009-161528

(51) Int. Cl. G06F 3/041; H01H 1/10

(52) U.S. Cl. 345/173; 200/514

(57) ABSTRACT

An input device includes: a first substrate; a flexible second substrate arranged to be opposite the first substrate; a first electrode for depression position detection provided on the surface of the first substrate opposite the second substrate or on the side of the first substrate opposite to the second substrate; a second electrode for depression position detection provided on the second substrate; an insulating liquid material filled between the first substrate and the second substrate; and a region dividing member dividing a region where the insulating liquid material is filled between the first substrate and the second substrate into small sections with a gap through which the insulating liquid material flows.

### CROSS REFERENCES TO RELATED APPLICATIONS

The present application claims priority to Japanese Patent Application JP 2009-161528 filed on Jul. 8, 2009, the entire contents of which is hereby incorporated by reference.

### BACKGROUND

The present disclosure relates to an input device which detects a position depressed by a finger, a pen, or the like, and to an input function-equipped display device including the input device.

In various input devices (touch panels), as shown in FIG. 12A, a resistance film type input device is structured such that a first electrode 15 and a second electrode 25 are respectively formed on the opposing surfaces of a first substrate 10 and a second substrate 20 arranged to be opposite each other. In such an input device, when the second substrate 20 is depressed, the contact position of the first electrode 15 and the second electrode 25 is detected to detect input coordinates. When such an input device 1 is used in an input function-equipped display device, such as a mobile phone, a car navigation system, a personal computer, a ticket vending machine, or a banking terminal, the first substrate 10, the second substrate 20, the first electrode 15, and the second electrode 25 are made transparent, and a liquid crystal device is provided on the side of the first substrate 10 opposite to the second substrate 20. Thus, a user can input information while viewing an image displayed in an image display region of the liquid crystal device.

If an air layer which shows a significant difference in refractive index from a transparent conductive film constituting the first electrode 15 or the second electrode 25 is interposed between the first substrate 10 and the second substrate 20, transmittance is degraded due to reflection by the interface, and as a result, image visibility is degraded. Thus, a configuration has been suggested in which an insulating liquid material 49 which has a refractive index close to the refractive index of the first electrode 15 or the second electrode 25, for example, silicon oil is filled between the first substrate 10 and the second substrate 20 (see JP-A-2000-284913).

### SUMMARY

However, when the insulating liquid material 49 is filled between the first substrate 10 and the second substrate 20, if a depression position by a pen 9 or the like on the second substrate 20 is moved, there is a problem that a stripe occurs along the movement trajectory of the depression position, causing a user to feel displeasure. That is, as shown in FIG. 12B, if the second substrate 20 is depressed by the pen 9, as indicated by an arrow L1, the insulating liquid material 49 flows from the depressed location to the periphery. Meanwhile, if the depression is released, as shown in FIG. 12C, the second substrate 20 is away from the first substrate 10. As a result, as indicated by an arrow L2, the insulating liquid material 49 returns to the original location by negative pressure. At this time, a vacuum bubble 490 is generated when the insulating liquid material 49 returns, and a stripe 491 shown in FIG. 12D is generated along the movement trajectory of the depression location.

Thus, it is desirable to provide an input device which is capable of preventing a vacuum bubble from being viewed at a location where a depression on a second substrate is released even when an insulating liquid material is filled between a first substrate and a second substrate, and an input function-equipped display device including the input device.

An embodiment of the invention provides an input device. The input device includes a first substrate, a flexible second substrate arranged to be opposite the first substrate, a first electrode for depression position detection provided on the surface of the first substrate opposite the second substrate or on the side of the first substrate opposite to the second substrate, a second electrode for depression position detection provided on the second substrate, an insulating liquid material filled between the first substrate and the second substrate, and a region dividing member dividing a region where the insulating liquid material is filled between the first substrate and the second substrate into small sections with openings through which the insulating liquid material flows.

With this input device, if the second substrate is depressed, the first electrode and the second electrode are short-circuited at the depressed location, or the first electrode and the second electrode come close to each other. Thus, change in resistance or capacitance at that time is monitored, such that the depressed location on the second substrate can be detected. Further, since the insulating liquid material is filled between the first substrate and the second substrate, the reflection by the interface is small compared to a case where air is interposed between the first substrate and the second substrate. Thus, on the second substrate side, an image which has transmitted the first substrate and the second substrate is easily viewed. In addition, since the region dividing member is provided between the first substrate and the second substrate, the insulating liquid material is in a state of being divided into small sections. For this reason, even when vacuum bubbles are generated in the insulating liquid material, the region dividing member suppresses concentration of vacuum bubbles. Therefore, even when the insulating liquid material is filled between the first substrate and the second substrate, a vacuum bubble can be prevented from being viewed at a location where the depression on the second substrate is released, and as a result, a stripe can be prevented from being viewed along the movement trajectory when the depressed location is moved.

The region dividing member may be provided entirely in the thickness direction between the first substrate and the second substrate. With this configuration, it is possible to suppress concentration of vacuum bubbles generated any locations between the first substrate and the second substrate.

The region dividing member may be provided on at least one of the side of the insulating liquid material in contact with the first substrate and the side of the insulating liquid material in contact with the second substrate, and the region dividing member may not be provided partially in the thickness direction between the first substrate and the second substrate. Vacuum bubbles are likely to be generated on the side of the insulating liquid material in contact with the first substrate and the side of the insulating liquid material in contact with second substrate. With the above-described configuration, therefore, it is possible to suppress concentration of vacuum bubbles.

The region dividing member may be formed of a chain-like polymer compound, a reticulated polymer compound, or a cyclic polymer compound. With the region dividing member configured as above, there is no case where the first substrate and the second substrate are prevented from coming into contact with each other or coming close to each other at the location where the second substrate is depressed. In this case, the region dividing member is preferably a reticulated polymer compound (reticulated network). With the reticulated polymer compound (polymer network), it is possible to realize a state where the insulating liquid material is divided into very small sections. For this reason, even when vacuum bubbles are generated in the insulating liquid material, the region dividing member can more reliably suppress concentration of vacuum bubbles. Therefore, even when the insulating liquid material is filled between the first substrate and the second substrate, it is possible to more reliably prevent a vacuum bubble from being viewed at the location where the depression on the second substrate is released.

The region dividing member may be a plurality of insulating protrusions which protrude from one of the first substrate side and the second substrate side toward the other side. Even when the insulating protrusions are provided on at least one of the first substrate side and the second substrate side, the insulating liquid material can be in a state of being divided into small sections surrounded by the insulating protrusions. For this reason, even when vacuum bubbles are generated in the insulating liquid material, the region dividing member can suppress concentration of vacuum bubbles. Therefore, even when the insulating liquid material is filled between the first substrate and the second substrate, it is possible to prevent a vacuum bubble from being viewed at the location where the depression on the second substrate is released.

The embodiment may be applied to a resistance film type input device and a capacitance type input device. When the invention is applied to a resistance film type input device, the first electrode is a resistance film which is provided on the surface of the first substrate opposite the second substrate, and the second electrode is a resistance film which is provided on the surface of the second substrate opposite the first substrate. In the case of a resistance film type input device, since it is necessary to bring the first electrode and the second electrode into contact with each other, the second substrate is depressed deep. For this reason, since a large amount of insulating liquid material flows from the depressed location to the periphery, when the depression is released, a large amount of insulating liquid material should return to the location which is depressed until then. Thus, in the case of the resistance film type input device, vacuum bubbles are particularly easily generated. In contrast, according to the embodiment of the invention, since such vacuum bubbles are unlikely to be concentrated, even when the depressed location is moved, it is possible to suppress occurrence of a stripe along the movement trajectory.

An input device to which the invention is applied can be used in an input function-equipped display device. In this case, an image generating device is provided on the side of the first substrate opposite to the second substrate in an overlapping manner.

An input function-equipped display device to which the invention is applied is used in an electronic apparatus, such as a mobile phone, a car navigation system, a personal computer, a ticket vending machine, or a banking terminal.

Additional features and advantages are described herein, and will be apparent from the following Detailed Description and the figures.

### BRIEF DESCRIPTION OF THE FIGURES

FIG. 1 is an explanatory view schematically showing the overall configuration of an input function-equipped display device according to a first embodiment.

FIG. 2 is an explanatory view schematically showing the sectional configuration of the input function-equipped display device according to the first embodiment.

FIGS. 3A to 3C are explanatory views schematically showing the planar layout of electrodes formed in an input device 1 according to the first embodiment.

FIGS. 4A to 4D are explanatory views showing the configuration between a first substrate and a second substrate in the input device which is used in the input function-equipped display device according to the first embodiment.

FIG. 5 is an explanatory view schematically showing the sectional configuration of an input function-equipped display device according to a second embodiment.

FIGS. 6A to 6C are enlarged explanatory views showing the configuration between a first substrate and a second substrate in an input device which is used in the input function-equipped display device according to the second embodiment.

FIG. 7 is an explanatory view schematically showing the sectional configuration of an input function-equipped display device according to a third embodiment.

FIGS. 8A to 8C are enlarged explanatory views showing the configuration between a first substrate and a second substrate in an input device which is used in the input function-equipped display device according to the third embodiment.

FIGS. 9A to 9C are explanatory views schematically showing the planar layout of electrodes formed in an input device according to the third embodiment.

FIGS. 10A to 10C are explanatory views of a capacitance type input device according to a fourth embodiment.

FIGS. 11A to 11C are explanatory views of an electronic apparatus using an input function-equipped display device according to an embodiment.

FIGS. 12A to 12D are explanatory views showing the problems in an input device of the related art.

### DETAILED DESCRIPTION

Embodiments will be described with reference to the drawings. In the drawings for the following description, the size of each layer or member is adjusted to be recognizable on the drawings.

### First Embodiment

### Overall Configuration

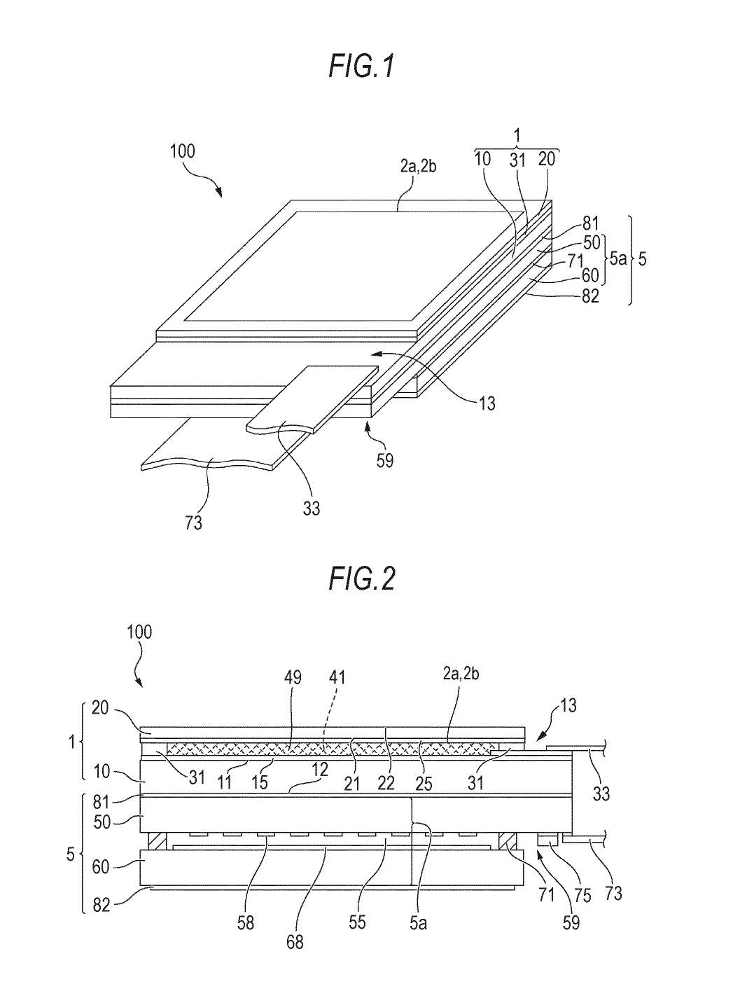

FIG. 1 is an explanatory view schematically showing the overall configuration of an input function-equipped display device according to a first embodiment. FIG. 2 is an explanatory view schematically showing the sectional configuration of the input function-equipped display device.

In FIGS. 1 and 2, an input function-equipped display device 100 of this embodiment generally has a liquid crystal device 5 which serves as an image generating device, and an input device 1 (touch panel) which is arranged in an overlapping manner on the side of the liquid crystal device 5 where display light is emitted. The liquid crystal device 5 includes a transmissive, reflective, or transflective active matrix type liquid crystal panel 5a. In this embodiment, since the liquid crystal panel 5a is a transmissive liquid crystal panel, a backlight device (not shown) is arranged on the opposite side to the emission side of display light. In the liquid crystal device 5, a first polarizing plate 81 is arranged in an overlapping manner on the emission side of display light of the liquid crystal panel 5a, and a second polarizing plate 82 is arranged in an overlapping manner on the opposite side.

The liquid crystal panel 5a includes a transparent element substrate 50 which is arranged on the emission side of display light, and a transparent counter substrate 60 which is arranged to be opposite the element substrate 50. The counter substrate 60 and the element substrate 50 are bonded to each other by a rectangular frame-shaped sealant 71. A liquid crystal layer 55 is retained in a region surrounded by the sealant 71 between the counter substrate 60 and the element substrate 50.

A plurality of pixel electrodes 58 are formed of a transparent conductive film, such as an ITO (Indium Tin Oxide) film, on the surface of the element substrate 50 opposite the counter substrate 60. A common electrode 68 is formed of a transparent conductive film, such as an ITO film, on the surface of the counter substrate 60 opposite the element substrate 50. When the liquid crystal device 5 uses an IPS (In-Plane Switching) system or an FFS (Fringe Field Switching) system, the common electrode 68 is provided on the element substrate 50. The element substrate 50 may be arranged on the emission side of display light.

A drive IC 75 is COG mounted in an extended region 59 of the element substrate 50 extending from the edge of the counter substrate 60. A flexible board 73 is connected to the extended region 59. The element substrate 50 may be configured such that a drive circuit is formed simultaneously with switching elements on the element substrate 50.

(Detailed Configuration of Input Device 1)

The input device 1 of this embodiment includes a transparent first substrate 10 which is formed of a glass plate, a plastic plate, or the like, and a transparent second substrate 20 which is formed of a glass plate, a plastic plate, a plastic sheet, or the like. When the first substrate 10 and the second substrate 20 are formed of plastic materials, the plastic materials, such as PC (polycarbonate), PES (polyethersulfone), or PI (polyimide), may be used. In this embodiment, for both of the first substrate 10 and the second substrate 20, a glass plate is used.

The first substrate 10 and the second substrate 20 are bonded to each other by a rectangular frame-shaped sealant 31 such that first surfaces 11 and 21 thereof are opposite each other with a predetermined gap. The second substrate 20 is arranged on an input operation side, and the first substrate 10 is arranged on the liquid crystal device 5 side. For this reason, a second surface 22 of the second substrate 20 is directed toward the input operation side, and a second surface 12 of the first substrate 10 is directed toward the liquid crystal device 5. In the input device 1, when the second substrate 20 is depressed to carry out an input, the second substrate 20 should be flexed toward the first substrate 10 at the depressed location. For this reason, the second substrate 20 has a smaller thickness than the first substrate 10 and is flexible.

A flexible board 33 is connected to an extended region 13 extending from the edge of the second substrate 20 on the first surface 11 of the first substrate 10. The flexible board 33 is a wiring member which outputs signals from the input device 1 to the outside.

In this embodiment, the input device 1 is configured such that the second surface 12 of the first substrate 10 is adhered to the first polarizing plate 81 by a transparent adhesive (not shown), such as acrylic resin.

(Electrode Configuration of Input Device 1)

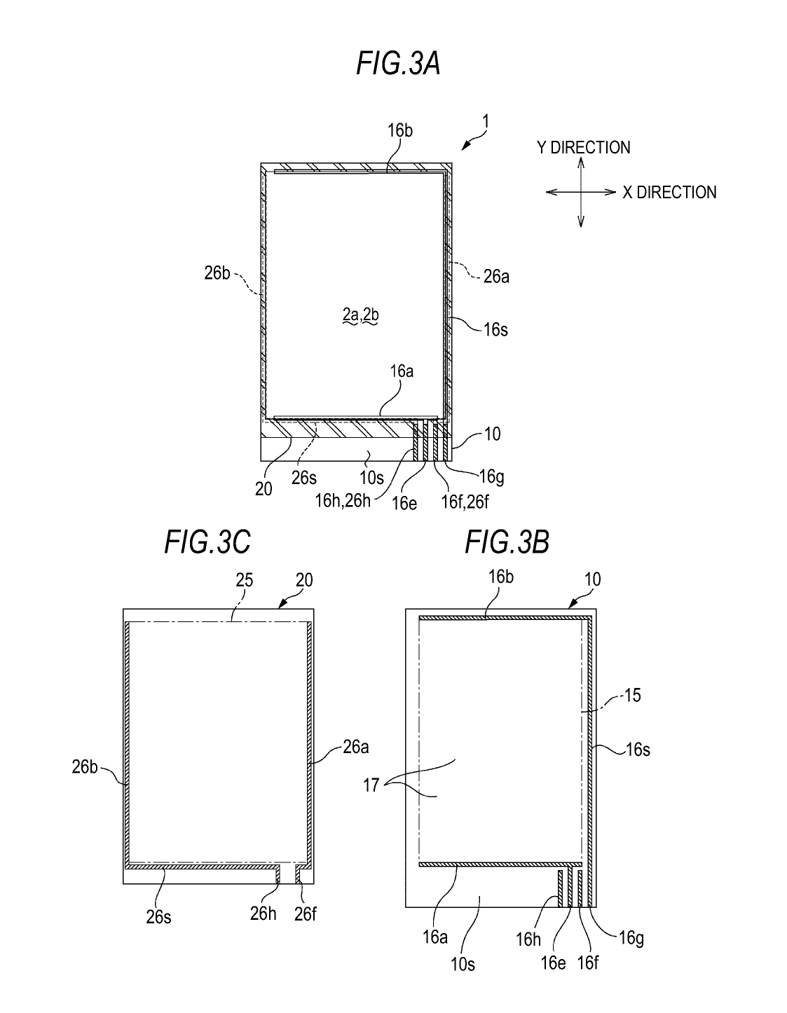

FIGS. 3A to 3C are explanatory views schematically showing the planar layout of electrodes formed in the input device 1 according to the first embodiment. FIG. 3A is an explanatory view showing the planar positional relationship between electrodes formed on the first substrate 10 and the second substrate 20 of the input device 1. FIG. 3B is an explanatory view schematically showing the planar configuration of an electrode formed on the first substrate. FIG. 3C is an explanatory view schematically showing the planar configuration of an electrode formed on the second substrate. In FIG. 3A, a strip-shaped electrode formed on the first substrate 10 is indicated by a solid line, and a strip-shaped electrode formed on the second substrate 20 is indicated by a dotted line. In FIGS. 3B and 3C, sheet-like electrodes (resistance films) for depression position detection formed on the first substrate 10 and the second substrate 20 are indicated by one-dot-chain lines. In the following description, the directions (in this embodiment, orthogonal directions) which cross each other on the substrate surfaces of the first substrate 10 and the second substrate 20 used in the input device 1 are respectively referred to as the X direction and the Y direction.

As shown in FIGS. 1 and 2, in the input device 1 of this embodiment, a sheet-like first electrode 15 (first resistance film) for depression position detection is provided over an input region 2a of the first surface 11 of the first substrate 10, and a sheet-like second electrode 25 (second resistance film) for depression position detection is provided over an input region 2a of the first surface 21 of the second substrate 20. In this embodiment, the first electrode 15 and the second electrode 25 are both formed of transparent conductive films, such as ITO films.

A pair of first strip-shaped electrodes 16a and 16b are provided at both opposing ends in the Y direction of the first electrode 15 on the first surface 11 of the first substrate 10. The first strip-shaped electrodes 16a and 16b are metal electrodes which are respectively laminated on the upper layers at both opposing ends in the Y direction of the first electrode 15, and are formed of silver, a silver alloy, or the like. For this reason, the first strip-shaped electrodes 16a and 16b have low sheet resistance compared to the first electrode 15. Four terminals 16e, 16f, 16g, and 16h are provided near one corner from among the four corners of the first substrate 10. Of a pair of first strip-shaped electrodes 16a and 16b, the first strip-shaped electrode 16a extends from one end of the terminal 16e in parallel to a substrate side on one side in the Y direction. A relay electrode 16s extends from the terminal 16g along the substrate side on one side in the X direction. The first strip-shaped electrode 16b extends from the front end of the relay electrode 16s along the substrate side on the other side in the Y direction.

A pair of second strip-shaped electrodes 26a and 26b are provided at both opposing ends in the X direction of the second electrode 25 on the first surface 21 of the second substrate 20. In this embodiment, the second strip-shaped electrodes 26a and 26b are metal electrodes which are respectively laminated on the upper layers at both opposing ends in the X direction of the second electrode 25, and are formed of silver, a silver alloy, or the like, similarly to the first strip-shaped electrodes 16a and 16b. For this reason, the second strip-shaped electrodes 26a and 26b have low sheet resistance compared to the second electrode 25. Two terminals 26f and 26h are provided at an end of the second substrate 20. Of a pair of second strip-shaped electrodes 26a and 26b, the second strip-shaped electrode 26a extends from one end of the terminal 26f along the substrate side on one side in the X direction. A relay electrode 26s extends from the terminal 26h along the substrate side on one side in the Y direction. The second strip-shaped electrode 26b extends from the front end of the relay electrode 26s along the substrate side on the other side in the X direction.

If the second substrate 20 is arranged to be opposite the first substrate 10 configured as above, the terminals 26f and 26h provided on the second substrate 20 overlap the terminals 16f and 16h provided on the first substrate 10. On the first surface 11 of the first substrate 10, the flexible board 33 (see FIG. 1) is connected to one end of the terminals 16e, 16f, 16g, and 16h in the extended region 13.

The sealant 31 shown in FIG. 2 is configured such that, in a portion of the sealant 31 coated in the region where the terminals 16e, 16f, 16g, 16h, 26f, and 26h are formed, an inter-substrate conducting material (not shown) which is formed by a plastic bead or the like with a metal layer provided on the surface thereof is arranged. Thus, the terminals 26f and 26h of the second substrate 20 are conductively connected to the terminals 16f and 16h of the first substrate 10 through the inter-substrate conducting material. For this reason, the first strip-shaped electrode 16a is electrically connected to an input position detection circuit through the terminal 16e and the flexible board 33, and the first strip-shaped electrode 16b is electrically connected to the input position detection circuit through the relay electrode 16s, the terminal 16g, and the flexible board 33. The second strip-shaped electrode 26a is electrically connected to the input position detection circuit through the terminal 26f, the terminal 16f, and the flexible board 33, and the second strip-shaped electrode 26b is electrically connected to the input position detection circuit through the relay electrode 26s, the terminal 26h, the terminal 16h, and the flexible board 33.

In the input device 1, the first substrate 10 and the second substrate 20 have both a planar rectangular shape. The sealant 31 is arranged so as to follow the outer edge of the first substrate 10 and the second substrate 20. For this reason, the sealant 31 is provided to have a rectangular frame shape, and a central region of a rectangular region 2b surrounded by the sealant 31 is used as the input region 2a.

(Configuration Between First Substrate 10 and Second Substrate 20)

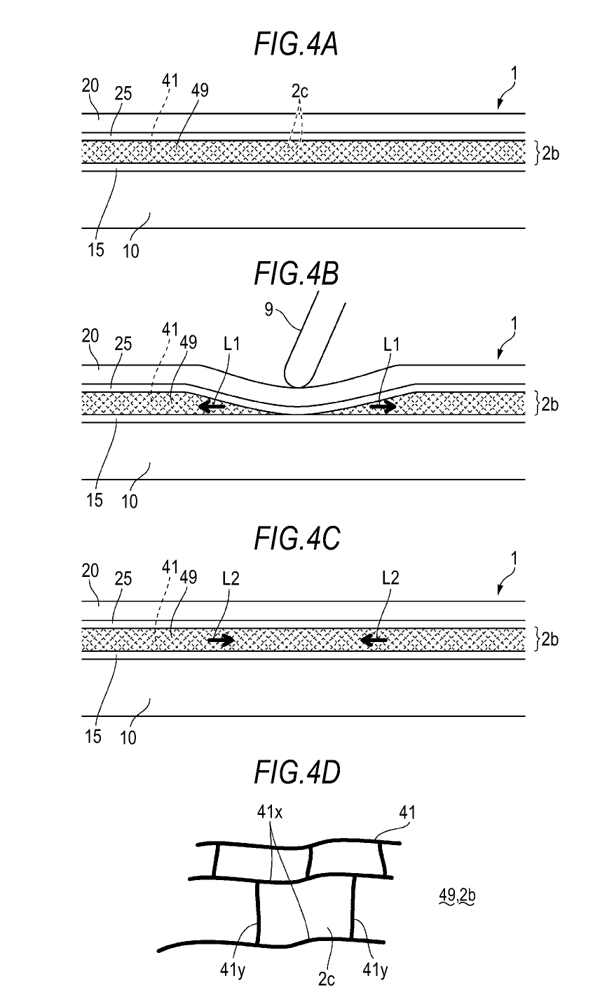

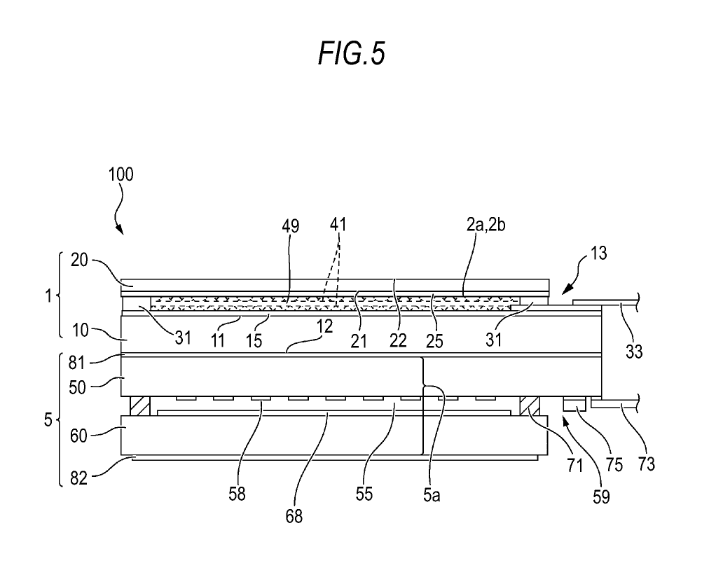

FIGS. 4A to 4D are explanatory views showing the configuration between the first substrate 10 and the second substrate 20 in the input device 1 which is used in the input function-equipped display device 100 according to the first embodiment of the invention. FIG. 4A is an explanatory view showing the state of the input device 1 before the second substrate 20 is depressed. FIG. 4B is an explanatory view showing the state of the input device 1 where the second substrate 20 is depressed by a pen. FIG. 4C is an explanatory view showing the state of the input device 1 where a depression on the second substrate 20 is released. FIG. 4D is an explanatory view of the region dividing member.

In the input device 1 shown in FIGS. 2 and 4A, if an air layer is provided between the first substrate 10 and the second substrate 20, the transmittance of the input device 1 is degraded due to reflection by the interface between the air layer and the first electrode 15 or reflection by the interface between the air layer and the second electrode 25, and as a result, image visibility is degraded. Accordingly, in this embodiment, the insulating liquid material 49 having a refractive index greater than air is filled in the region 2b surrounded by the sealant 31 between the first substrate 11 and the second substrate 20. When the air layer is provided between the first substrate 10 and the second substrate 20, the transmittance of the input device 1 is about 85% with a wavelength range of 380 to 780 nm. In contrast, if the insulating liquid material 49 is filled between the first substrate 10 and the second substrate 20, the transmittance of the input device 1 can be increased to be equal to or greater than about 90% with the wavelength range of 380 to 780 nm.

As the insulating liquid material 49, oils, such as paraffin-based oil, petroleum-based oil, vegetable oil, and silicon oil, alcohols, hydrocarbons, ketones, esters, ethers, water, and liquid crystal materials may be used. In this embodiment, as the insulating liquid material 49, silicon oil (refractive index: 1.4) or the like is used which has a refractive index same as ITO (refractive index: 1.9) constituting the first electrode 15 or the second electrode 25.

In the input device 1 of this embodiment, a region dividing member 41 is interposed between the first substrate 10 and the second substrate 20 to divide the filled region (region 2b) of the insulating liquid material 49 between the first substrate 10 and the second substrate 20 into small sections 2c with openings through which the insulating liquid material 49 can flow. For this reason, the insulating liquid material 49 is filled in a state of being divided into the small sections 2c. Since large openings are provided in the region dividing member 41, the insulating liquid material 49 can flow between adjacent small sections 2c.

In this embodiment, the region dividing member 41 is a reticulated polymer compound (polymer network) and is substantially uniformly distributed entirely in the thickness direction and the in-plane direction between the first substrate 10 and the second substrate 20. As shown in FIG. 4D, such a reticulated polymer compound can be structured to have chainlike extended portions 41x and connection portions 41y which connect the extended portions 41x. Thus, the filled region (region 2b) of the insulating liquid material 49 can be in a state of being divided into the small sections 2c with openings through which the insulating liquid material 49 can flow.

The region dividing member 41 configured as above can be formed, for example, by filling and polymerizing the insulating liquid material 49 in the region 2b surrounded by the sealant 31 between the first substrate 10 and the second substrate 20 in a state where a photo-curable (ultraviolet curable) monomer or a photo-curable (ultraviolet curable) oligomer is dispersed in the insulating liquid material 49. At this time, ultraviolet irradiation from the first substrate 10 side and ultraviolet irradiation from the second substrate 20 side are performed, and also the irradiation amount of ultraviolet rays is controlled. As a result, a polymerization reaction proceeds entirely or substantially entirely over the monomer or oligomer dispersed in the insulating liquid material 49. As the monomer or oligomer for the region dividing member 41, for example, the materials for forming a “polymer dispersion” in liquid crystal described in JP-A-2000-317174 may be used.

For example, if 2′-methyl-p-terphenyl-4,4″-diyl dimethacrylate expressed by the following formula (1) is used as the monomer for forming the insulating liquid material 49, a reticulated polymer compound (reticulated network/polymer network) expressed by the following formula (2) is formed. The mixed amount of the monomer in the insulating liquid material 49 is preferably in a range of 0.1 to 5% by weight. If the mixed amount is lower than 0.1% by weight, the effect of dividing the region 2b is insufficient. If the mixed amount exceeds 5% by weight, the fluidity of the insulating liquid material 49 may be excessively suppressed.

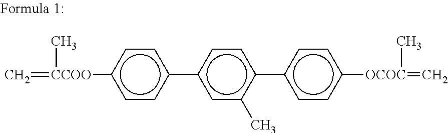

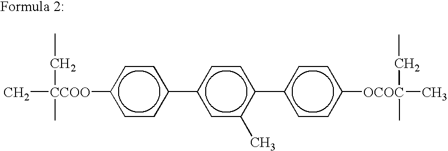

As the monomer, in addition to 2′-methyl-p-terphenyl-4,4″-diyl dimethacrylate, monomers shown in Tables 2 to 6 JP-A-2000-317174 may be used. For the insulating liquid material 49, in addition to the above-described materials, a monomer expressed by the following formula (3) may be used.

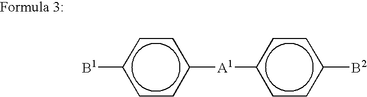

In the formula (3), B¹ and B² represent any one of a methacrylate group, an acrylate group, a hydrogen atom, an alkyl group, an alkoxy group, a fluorine atom, and a cyano group. At least one of B¹ and B² represents any one of a methacrylate group and an acrylate group. There is no B¹ and benzene rings on both sides are directly bonded to each other by single bond, or when B¹ may be any one of any group in the following formula (4), an oxygen atom, or sulfur atom. Further, hydrogen atoms of benzene rings on both sides of A¹ may both be hydrogen atoms, or at least one hydrogen atom may be substituted with a halogen atom.

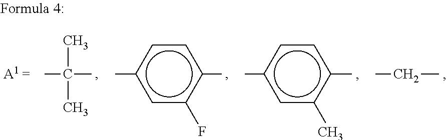

In forming the region dividing member 41 of a reticulated polymer compound, in addition to an ultraviolet curable monomer or oligomer, a thermosetting monomer or oligomer may be used. Specifically, for example, a compound having an epoxy group as expressed by the following formula (5), (6), or (7), alcohols expressed by the following formula (8), or a mixed monomer with amine (for example, (4-(ω-aminoalkoxy)-4′-cyanobiphenyl) expressed by the following formula (9) may be used. When such a monomer is used, the region dividing member 41 can be obtained by filling the insulating liquid material 49 between the first substrate 10 and the second substrate 20 in a state where the above-described monomer is dispersed in the insulating liquid material 49, and heating and polymerizing the insulating liquid material 49. At this time, heating is carried out at 60° C. for about three hours, for example.

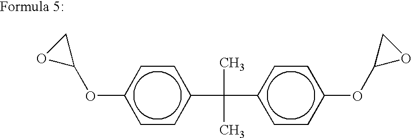

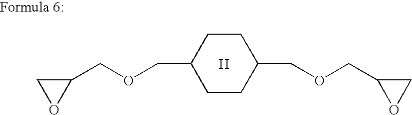

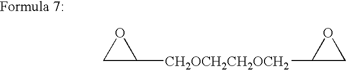

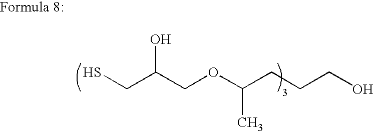

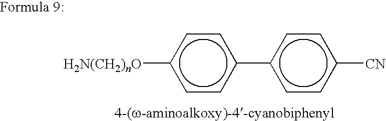

The monomer may be used as the insulating liquid material 49 itself. That is, if the monomer is filled between the first substrate 10 and the second substrate 20, and polymerized by ultraviolet irradiation, the region dividing member 41 is formed of a reticulated polymer compound (reticulated network), and an unreacted monomer remains as the insulating liquid material 49. With this configuration, in a portion where the reticulated region dividing member 41 is formed, the insulating liquid material 49 is in a state of being filled in the vacancy of the region dividing member 41.

A polymer material may be formed as a chainlike or cyclic polymer compound other than a reticulated type according to the type of a used monomer or the polymerization condition. Such a polymer material may be used as the region dividing member 41.

(Operation)

In the input device 1 of this embodiment, to carry out an input operation, the user depresses a predetermined position of the second substrate 20 by a finger or a pen. As a result, at the depressed location, the second substrate 20 is flexed toward the first substrate 10, and the first electrode 15 and the second electrode 25 come into contact with each other. Here, in detecting the contact position in the X direction, a voltage in the X direction is applied to the second electrode 25 through the second strip-shaped electrodes 26a and 26b, and the input position detection circuit monitors the potential through the first electrode 15 provided on the first substrate 10. Thus, when the second substrate 20 is depressed and the first electrode 15 and the second electrode 25 come into contact with each other, the contact position in the X direction can be detected by resistance division in the second electrode 25.

In detecting the contact position in the Y direction, a voltage in the Y direction is applied from the input position detection circuit to the first electrode 15 through the first strip-shaped electrodes 16a and 16b, and the input position detection circuit monitors the potential through the second electrode 25 provided on the second substrate 20. Thus, when the second substrate 20 is depressed and the first electrode 15 and the second electrode 25 come into contact with each other, the contact position in the Y direction can be detected by resistance division in the first electrode 15.

(Main Effects of this Embodiment)

As described above, in the input device 1 of this embodiment, as shown in FIG. 4B, for example, if the second substrate 20 is depressed by the pen 9, the insulating liquid material 49 flows from the depressed location to the periphery as indicated by the arrow L1. Then, as shown in FIG. 4C, if the depression is released, the second substrate 20 is away from the first substrate 10. As a result, the location depressed until then undergoes negative pressure, thus the insulating liquid material 49 returns toward the location depressed until then as indicated by the arrow L2. At this time, if the return of the insulating liquid material 49 is slow, vacuum bubbles are generated. In this embodiment, since the region dividing member 41 is provided between the first substrate 10 and the second substrate 20, the insulating liquid material 49 is in a state of being divided into the small sections 2c. For this reason, even when vacuum bubbles are generated in the insulating liquid material 49, the region dividing member 41 suppresses concentration of vacuum bubbles, and a vacuum bubble of a visible size is unlikely to be generated. Therefore, even when the insulating liquid material 49 is filled between the first substrate 10 and the second substrate 20, a vacuum bubble can be prevented from being viewed at the location where the depression on the second substrate 20 is released, and as a result, a stripe can be prevented from being viewed along the movement trajectory when the depressed position by the pen or the like is moved.

In this embodiment, the region dividing member 41 is a reticulated polymer compound (polymer network) and is freely modified. For this reason, when the second substrate 20 is depressed, there is no case where the first electrode 15 on the first substrate 10 side and the second electrode 25 on the second substrate 20 side are prevented from coming into contact with each other. Further, since the region dividing member 41 is a reticulated polymer compound, the region dividing member 41 divides the region 2b filled with the insulating liquid material 49 into the very small sections 2c. For this reason, the insulating liquid material 49 is in a state of being divided into the very small sections 4c. Thus, even when vacuum bubbles are generated in the insulating liquid material 49, it is possible to reliably suppress concentration of vacuum bubbles. Therefore, even when the insulating liquid material 49 is filled between the first substrate 10 and the second substrate 20, a vacuum bubble can be prevented from being viewed at the location where the depression of the second substrate 20 is released.

The insulating liquid material 49 and the region dividing member 41 provided in this embodiment can be applied to a capacitance type input device, in addition to the resistance film type input device 1 of this embodiment. However, in the case of the resistance film type input device 1, since the first electrode 15 and the second electrode 25 should come in contact with each other, the second substrate 20 is depressed deep. For this reason, in the case of the resistance film type input device 1, vacuum bubbles are particularly easily generated. In contrast, according to this embodiment, since a vacuum bubble is unlikely to be viewed, even when the depressed location by the pen or the like is moved in the resistance film type input device 1, it is possible to reliably suppress occurrence of a stripe along the movement trajectory.

### Second Embodiment

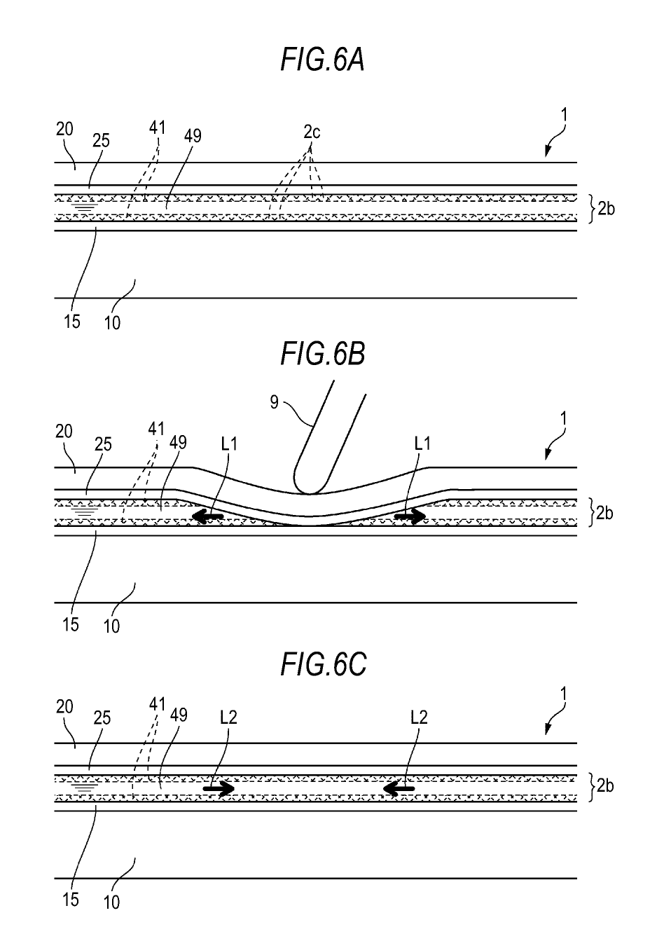

FIG. 5 is an explanatory view schematically showing the sectional configuration of an input function-equipped display device according to a second embodiment. FIGS. 6A to 6C are enlarged explanatory views showing the configuration between a first substrate 10 and a second substrate 20 in an input device 1 which is used in an input function-equipped display device 100 according to the second embodiment. FIG. 6A is an explanatory view showing the state of the input device 1 before the second substrate 20 is depressed. FIG. 6B is an explanatory view showing the state of the input device 1 where the second substrate 20 is depressed by the pen. FIG. 6C is an explanatory view showing the state of the input device 1 where a depression on the second substrate 20 is released. The basic configuration of this embodiment is the same as in the first embodiment, thus the common parts are represented by the same reference numerals and detailed description thereof will be omitted.

In FIG. 5, similarly to the first embodiment, the input function-equipped display device 100 of this embodiment has a liquid crystal device 5 which serves as an image generating device, and an input device 1 which is arranged in an overlapping manner on the surface of the liquid crystal device 5 where display light is emitted. The input device 1 includes a transparent first substrate 10 which is formed of a glass plate, a plastic plate, or the like, and a transparent second substrate 20 which is formed of a glass plate, a plastic plate, a plastic sheet, or the like. In this embodiment, for both of the first substrate 10 and the second substrate 20, a glass plate is used. Similarly to the first embodiment, the input device 1 is configured such that a transparent first electrode 15 (first resistance film) formed of an ITO film is provided over an entire input region 2a of a first surface 11 of the first substrate 10, and a transparent second electrode 25 (second resistance film) formed of an ITO film is provided over an entire input region 2a of a first surface 21 of the second substrate 20. An insulating liquid material 49 having a refractive index greater than air is filled in a region surrounded by a sealant 31 between the first substrate 10 and the second substrate 20.

In the input device 1 of this embodiment, similarly to the first embodiment, a region dividing member 41 is provided between the first substrate 10 and the second substrate 20 to divide the filled region (region 2b) of the insulating liquid material 49 between the first substrate 10 and the second substrate 20 into small section 2c with openings through which the insulating liquid material 49 can flow. For this reason, the insulating liquid material 49 is filed in a state of being divided into the small sections 2c. Since large openings are provided in the region dividing member 41, the insulating liquid material 49 can flow between adjacent small sections 2c.

In this embodiment, the region dividing member 41 is substantially uniformly provided entirely over the in-plane direction of the region 2b. Meanwhile, in this embodiment, as shown in FIGS. 5 and 6A, unlike the first embodiment, the region dividing member 41 is formed only on the side of the insulating liquid material 49 in contact with the first substrate 10 (first electrode 15) and the side of the insulating liquid material 49 in contact with the second substrate 20 (second electrode 25). For this reason, the region dividing member 41 is not provided entirely in the thickness direction between the first substrate 10 and the second substrate 20, and the region dividing member 41 is not provided in a portion (intermediated portion) between the first substrate 10 and the second substrate 20.

In this embodiment, similarly to the first embodiment, the region dividing member 41 is the reticulated polymer compound (polymer network) described with reference to FIG. 4D, and can be obtained by filling the insulating liquid material 49 between the first substrate 10 and the second substrate 20 in a state where the photo-curable monomer or photo-curable oligomer of the region dividing member 41 is dispersed in the insulating liquid material 49 and polymerizing the monomer or oligomer. At this time, ultraviolet irradiation from the first substrate 10 side and ultraviolet irradiation from the second substrate 20 side are carried out, and also the irradiation amount of ultraviolet rays is controlled. As a result, a polymerization reaction proceeds only in the monomer or oligomer distributed on the side of the insulating liquid material 49 in contact with the first substrate 10 (first electrode 15) and the side of the insulating liquid material 49 in contact with the second substrate 20 (second electrode 25) from among the monomer or oligomer dispersed in the insulating liquid material 49.

In forming the region dividing member 41 of a reticulated polymer compound, similarly to the first embodiment, in addition to an ultraviolet curable monomer or oligomer, a thermosetting monomer or oligomer may be used. When a thermosetting monomer or oligomer is used, the insulating liquid material 49 is filled and polymerized between the first substrate 10 and the second substrate 20 in a state where the monomer or oligomer of the region dividing member 41 is dispersed in the insulating liquid material 49. At this time, heating from the first substrate 10 side and heating from the second substrate 20 side are carried out, and also the amount of heat is controlled. As a result, a polymerization reaction proceeds only in the monomer or oligomer distributed on the side of the insulating liquid material 49 in contact with the first substrate 10 (first electrode 15) and the side of the insulating liquid material 49 in contact with the second substrate 20 (second electrode 25) from among the monomer or oligomer dispersed in the insulating liquid material 49.

In this embodiment, the monomer may be used as the insulating liquid material 49 itself. That is, if the monomer is filled and polymerized between the first substrate 10 and the second substrate 20, the region dividing member 41 is formed of a reticulated polymer compound, and an unreacted monomer remains as the insulating liquid material 49. With this configuration, in a portion where the reticulated region dividing member 41 is formed, the insulating liquid material 49 is in a state of being filled in the vacancy of the region dividing member 41.

In the input device 1 configured as above, similarly to the first embodiment, as shown in FIG. 6B, for example, if the second substrate 20 is depressed by the pen 9, the insulating liquid material 49 flows from the depressed location to the periphery as indicated by an arrow L1. Then, as shown in FIG. 6C, if the depression is released, the second substrate 20 is away from the first substrate 10, and the insulating liquid material 49 returns toward the location depressed until then as indicated by an arrow L2. At this time, if the return of the insulating liquid material 49 is slow, vacuum bubbles are generated. In this embodiment, similarly to the first embodiment, the insulating liquid material 49 is filled in a state of being divided into the small sections 2c by the region dividing member 41. For this reason, the region dividing member 41 suppresses concentration of vacuum bubbles, thus a vacuum bubble can be prevented from being viewed. Therefore, similarly to the first embodiment, a stripe can be prevented from being viewed along the movement trajectory when the depressed location by the pen or the like is moved.

In this embodiment, the region dividing member 41 is formed on both of the side of the insulating liquid material 49 in contact with the first substrate 10 (first electrode 15) and the side of the insulating liquid material 49 in contact with the second substrate 20 (second electrode 25). Meanwhile, the region dividing member 41 may be formed on one of the side of the insulating liquid material 49 in contact with the first substrate 10 (first electrode 15) and the side of the insulating liquid material 49 in contact with the second substrate 20 (second electrode 25).

### Third Embodiment

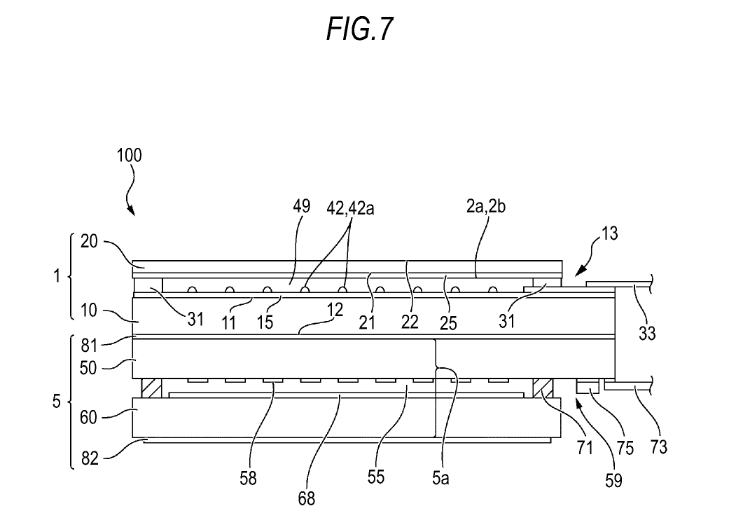

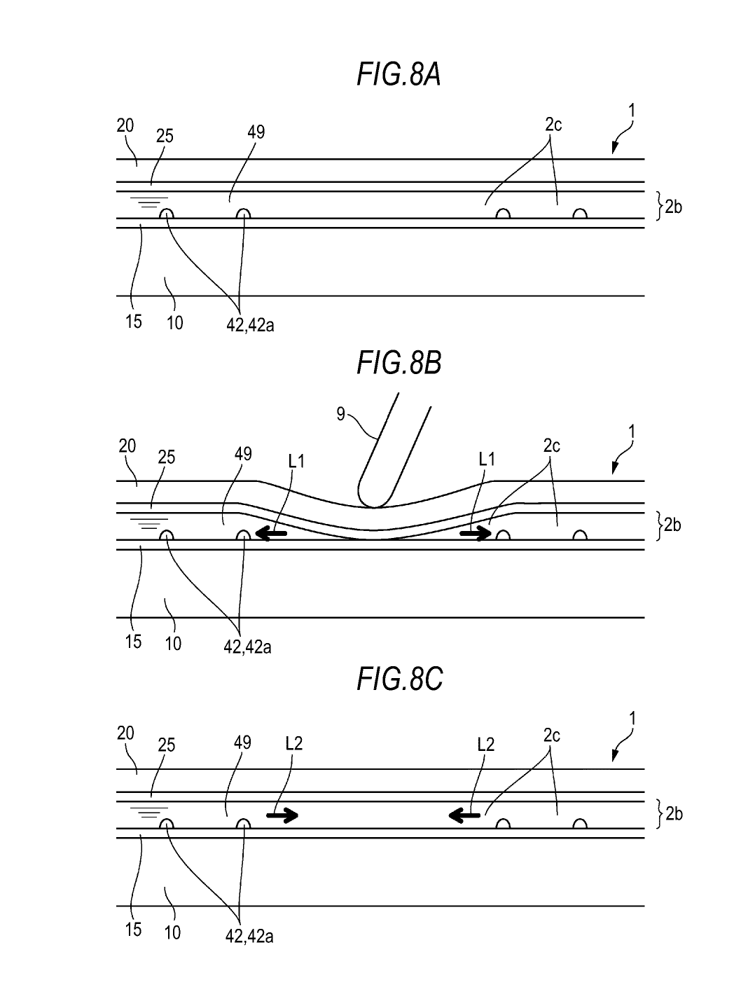

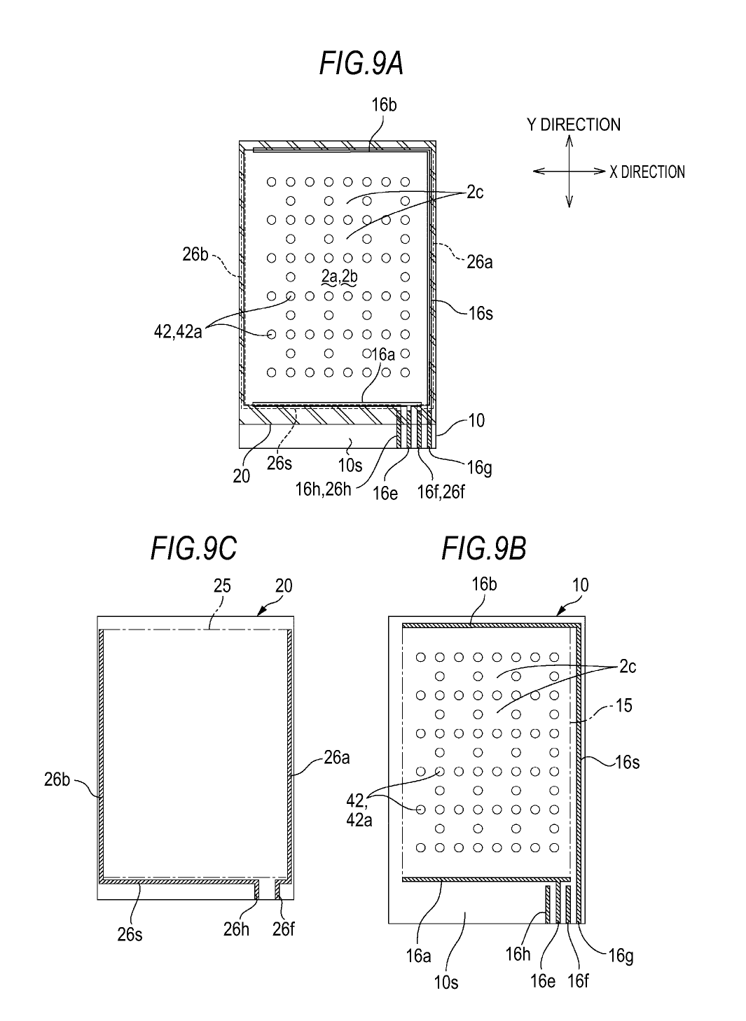

FIG. 7 is an explanatory view schematically showing the sectional configuration of an input function-equipped display device according to a third embodiment. FIGS. 8A to 8C are explanatory views showing the configuration between a first substrate 10 and a second substrate 20 in an input device 1 which is used in an input function-equipped display device 100 according to the third embodiment. FIG. 8A is an explanatory view showing the state of the input device 1 before the second substrate 20 is depressed. FIG. 8B is an explanatory view showing the state of the input device 1 where the second substrate 20 is depressed by the pen. FIG. 8C is an explanatory view showing the state of the input device 1 where a depression on the second substrate 20 is released. FIGS. 9A to 9C are explanatory views schematically showing the planar layout of electrodes formed in the input device 1 according to the third embodiment of the invention. FIG. 9A is an explanatory view showing the planar positional relationship between electrodes formed on the first substrate 10 and the second substrate 20 of the input device 1. FIG. 9B is an explanatory view schematically showing the planar configuration of an electrode formed on the first substrate. FIG. 9C is an explanatory view schematically showing the planar configuration of an electrode formed on the second substrate. The basic configuration of this embodiment is the same as in the first embodiment, thus the common parts are represented by the same reference numerals and detailed description thereof will be omitted.

In FIG. 7, similarly to the first embodiment, the input function-equipped display device 100 of this embodiment has a liquid crystal device 5 which serves as an image generating device, and an input device 1 which is arranged in an overlapping manner on the surface of the liquid crystal device 5 where display light is emitted. The input device 1 includes a transparent first substrate 10 which is formed of a glass plate, a plastic plate, or the like, and a transparent second substrate 20 which is formed of a glass plate, a plastic plate, a plastic sheet, or the like. In this embodiment, for both of the first substrate 10 and the second substrate 20, a glass plate is used. Similarly to the first embodiment, the input device 1 is configured such that a transparent first electrode 15 (first resistance film) formed of an ITO film is provided over an entire input region 2a of a first surface 11 of the first substrate 10, and a transparent second electrode 25 (second resistance film) formed of an ITO film is provided over an entire input region 2a of a first surface 21 of the second substrate 20.

As shown in FIGS. 7 and 8A, an insulating liquid material 49 having a refractive index greater than air is filled in a region surrounded by a sealant 31 between the first substrate 10 and the second substrate 20. Further, similarly to the first embodiment, in the input device 1 of this embodiment, region dividing members 42 are interposed between the first substrate 10 and the second substrate 20 to suppress flowing of the insulating liquid material 49.

Unlike the first and second embodiments, the region dividing members 42 used in this embodiment are formed by a plurality of insulating protrusions 42a which protrude from the first electrode 15 of the first substrate 10 toward the second substrate 20. The region dividing members 42 (insulating protrusions 42a) are not provided on the second substrate 20 and the second electrode 25, and the region dividing members 42 (insulating protrusions 42a) are not provided partially (from the intermediate portion to the second substrate 20) in the thickness direction between the first substrate 10 and the second substrate 20.

As shown in FIGS. 9A, 9B, and 9C, the region dividing members 42 (insulating protrusions 42a) are distributed so as to divide a region where the first electrode 15 is formed into a plurality of small sections 2c. Specifically, the regions surrounded by the insulating protrusions 42a arranged in the X direction and the insulating protrusions 42a arranged in the Y direction form the small sections 2c. Further, since the region dividing members 42 (insulating protrusions 42a) are formed with a predetermined gap, an opening through which the insulating liquid material 49 can flow is provided between adjacent region dividing members 42.

The region dividing members 42 can be implemented, for example, by forming the first electrode 15 and the like on the first substrate 10 and then forming an insulating material on the upper layer of the first electrode 15 in a predetermined distribution. Specifically, when the region dividing members 42 are formed of, for example, photosensitive resin, the region dividing members 42 can be formed by exposing and developing sensitive resin, such as acrylic resin, coated on the upper layer of the first electrode 15 in a predetermined pattern. Further, when the region dividing members 42 are formed of, for example, an inorganic material, the region dividing members 42 can be formed by forming an inorganic film, such as a silicon oxide film, on the upper layer of the first electrode 15, forming a resist mask in a predetermined pattern, and patterning the inorganic film.

In the input device 1 configured as above, similarly to the first embodiment, as shown in FIG. 8B, for example, if the second substrate 20 is depressed by the pen 9, the insulating liquid material 49 flows from the depressed location to the periphery as indicated by an arrow L1. Then, as shown in FIG. 8C, if the depression is released, the second substrate 20 is away from the first substrate 10, and the insulating liquid material 49 returns toward the location depressed until then as indicated by an arrow L2. At this time, if the return of the insulating liquid material 49 is slow, vacuum bubbles are generated. In this embodiment, similarly to the first embodiment, the insulating liquid material 49 is filled in a state of being divided into the small regions 2c by the region dividing members 42. For this reason, the region dividing members 42 suppress concentration of vacuum bubbles, thus a vacuum bubble can be prevented from being viewed. Therefore, a stripe can be prevented from being viewed along the movement trajectory when the depressed location by the pen or the like is moved.

Although in this embodiment, the region dividing members 42 (a plurality of insulating protrusions 42a) are configured to protrude from the first electrode 15 of the first substrate 10 toward the second substrate 20, the region dividing members 42 (a plurality of insulating protrusions 42a) may be configured to protrude from the second substrate 20 toward the first substrate 10. Further, the region dividing members 42 (a plurality of insulating protrusions 42a) may be formed on both of the first substrate 10 and the second substrate 20.

### Fourth Embodiment

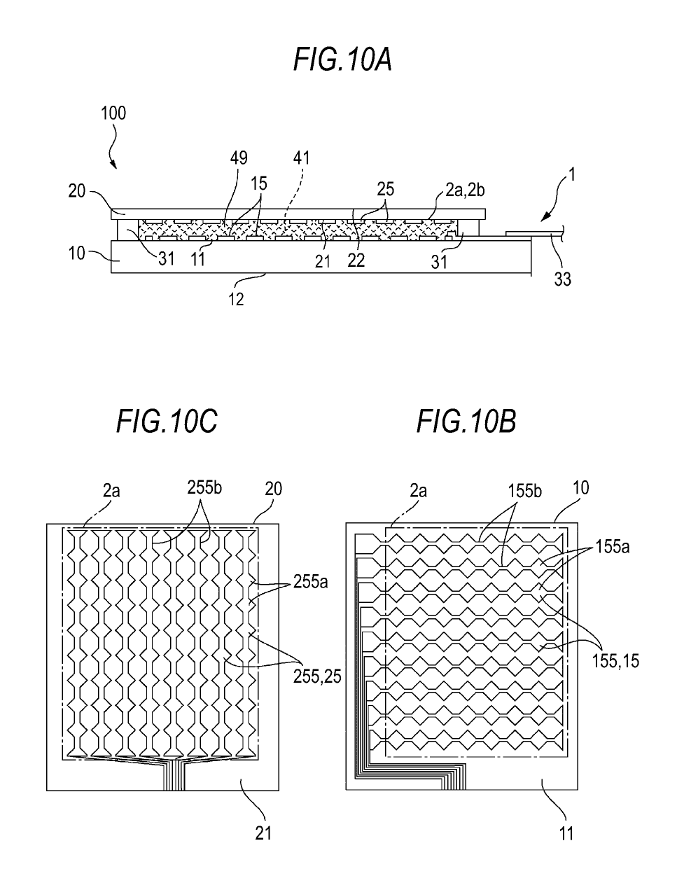

Although the foregoing embodiments are applied to a resistance film type input device, as described below, they may be applied to a capacitance type input device. FIGS. 10A to 10C are explanatory views of a capacitance type input device according to a fourth embodiment. FIG. 10A is a sectional view of a capacitance type input device according to the fourth embodiment. FIG. 10B is an explanatory view schematically showing the configuration of a first substrate 10. FIG. 10C is an explanatory view schematically showing the configuration of a second substrate 20. The basic configuration of this embodiment is the same as in the first embodiment, thus the common parts are represented by the reference numerals and description thereof will be omitted.

Although in the first to third embodiments, the first electrode 15 and the second electrode 25 are respectively formed to have a sheet shape on the first substrate 10 and the second substrate 20, in this embodiment, as shown in FIG. 10A, a plurality of first electrodes 15 and second electrodes 25 are respectively formed on the first substrate 10 and the second substrate 20.

Specifically, as shown in FIG. 10B, a plurality of first electrodes 15 are formed on a first surface 11 of the first substrate 10. The first electrodes 15 are formed of a plurality of columns of transparent electrode patterns 155 (electrode patterns) which extend in the X direction (second direction). Further, as shown in FIG. 10C, a plurality of second electrodes 25 are formed on a first surface 21 of the second substrate 20. The second electrodes 25 are formed of a plurality of columns of transparent electrode patterns 255 (electrode patterns) which extend in the Y direction (first direction). The first electrodes 15 and the second electrode 25 are both formed of ITO films.

The first electrodes 15 include a plurality of rhomboidal large-area pad portions 155a, and small-width connection portions 155b which connect the pad portions 155a. Similarly to the first electrodes 15, the second electrodes 25 include a plurality of rhomboidal large-area pad portions 255a, and small-width connection portions 255b which connect the pad portions 255a.

The first substrate 10 and the second substrate 20 configured as above are arranged, for example, such that the pad portions 155a and the pad portions 255a wholly overlap each other. Further, processing is carried out for applying a voltage across both ends of the first electrodes 15 and monitoring the potentials of a plurality of second electrodes 25 for each transparent electrode pattern 255, and processing is also carried out for applying a voltage across both ends of the second electrodes 25 and monitoring the potentials of a plurality of first electrodes 11 for each transparent electrode pattern 155. With this configuration, if the user depresses a predetermined position of the second substrate 20 by a finger or a pen to carry out an input operation, at the depressed location, the second substrate 20 is flexed toward the first substrate 10, and the facing distance between the first electrode 15 and the second electrode 25 changes, leading to change in capacitance. Thus, if an electrode pattern with increasing capacitance is specified from among a plurality of columns of transparent electrode patterns 155, the Y coordinate of the depressed position can be specified. Further, if an electrode pattern with increasing capacitance is specified from among a plurality of columns of transparent electrode patterns 255, the X coordinate of the depressed position can be specified.

In this input device 1, similarly to the first embodiment, if the insulating liquid material 49 having a refractive index greater than air is filled between the first substrate 10 and the second substrate 20, the transmittance of the input device 1 can be increased. In this embodiment, similarly to the first embodiment, if the region dividing member 41 is provided to divide the filled region (region 2b) of the insulating liquid material 49 between the first substrate 10 and the second substrate 20 into the small regions 2c with openings, advantages similar to the first embodiment such as prevention of a vacuum bubble from being viewed are obtained. Further, in the input device 1 of this embodiment, the region dividing member 41 or 42 which has been described in the second or third embodiment may be provided.

Although in this embodiment, the first electrodes 15 are formed on the first surface 11 of the first substrate 10, the first electrodes 15 may be formed on the side of the first substrate 10 opposite to the second substrate 20, for example, on the second surface 12. Further, although in this embodiment, the second electrodes 25 are formed on the first surface 21 of the second substrate 20, the second electrodes 25 may be formed on the second surface 22 of the second substrate 20.

### Other Embodiments

Although in the foregoing embodiments, the liquid crystal device 5 is used as an image generating device, an organic electroluminescence device may be used as an image generating device.

[Example of Mounting in Electronic Apparatus]

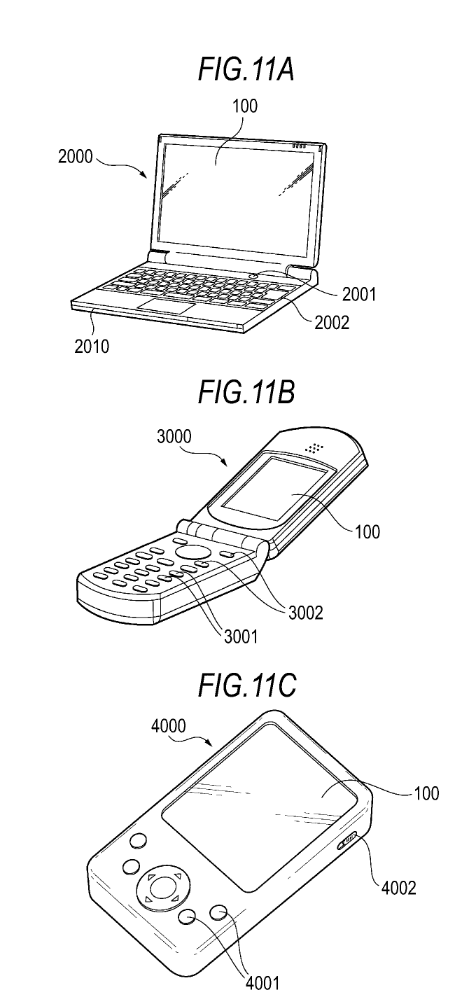

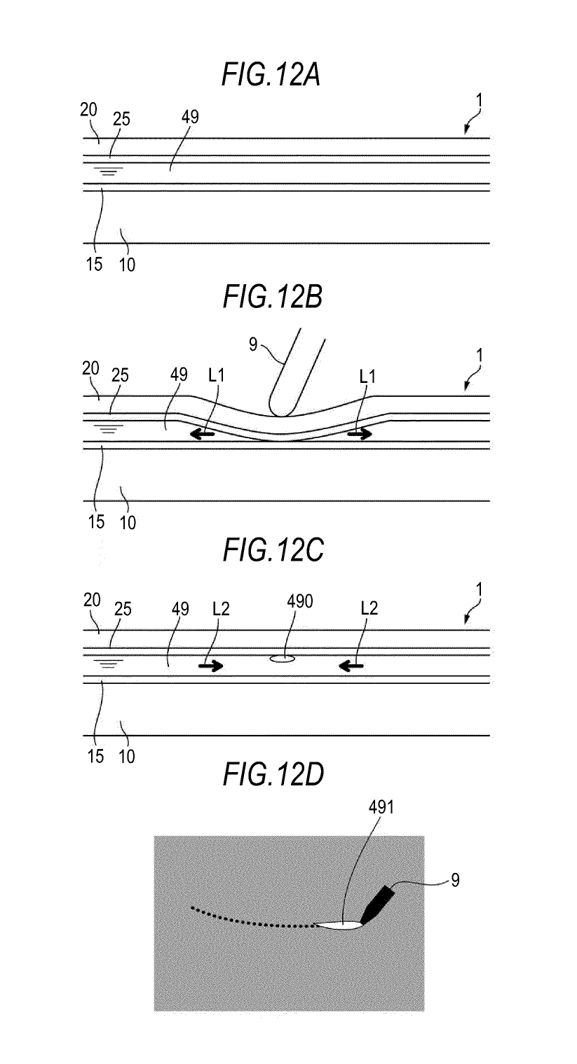

Next, an electronic apparatus will be described to which the input function-equipped display device 100 according to each of the foregoing embodiments is applied. FIG. 11A shows the configuration of a mobile personal computer including the input function-equipped display device 100. A personal computer 2000 includes the input function-equipped display device 100 serving as a display unit and a main body unit 2010. The main body unit 2010 is provided with a power switch 2001 and a keyboard 2002. FIG. 11B shows the configuration of a mobile phone including the input function-equipped display device 100. A mobile phone 3000 includes a plurality of operating buttons 3001, a scroll button 3002, and the input function-equipped display device 100 serving as a display unit. If the scroll button 3002 is operated, such that a screen displayed on the input function-equipped display device 100 is scrolled. FIG. 11C shows the configuration of a PDA (Personal Digital Assistant) to which the input function-equipped display device 100 is applied. The PDA 4000 includes a plurality of operating buttons 4001, a power switch 4002, and the input function-equipped display device 100 serving as a display unit. If the power switch 4002 is operated, various kinds of information, such as an address book or a diary, are displayed on the input function-equipped display device 100.

As the electronic apparatus to which the input function-equipped display device 100 is applied, in addition to the electronic apparatuses shown in FIGS. 11A to 11C, there are electronic apparatuses, such as a digital still camera, a liquid crystal television, a viewfinder-type or monitor-direct-view-type video tape recorder, a car navigation system, a pager, an electronic organizer, an electronic calculator, a word processor, a workstation, a video phone, a POS terminal, and a banking terminal. The above-described input function-equipped display device 100 can be applied as a display unit for various electronic apparatuses described above.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An input device comprising:
a first substrate;
a flexible second substrate arranged opposite to the first substrate;
a first electrode for depression position detection provided on a surface of the first substrate opposite the second substrate or on the side of a first substrate opposite to the second substrate;
a second electrode for depression position detection provided on the second substrate;
an insulating liquid material filled between the first substrate and the second substrate; and
a region dividing member dividing a region where the insulating liquid material is filled between the first substrate and the second substrate into small sections with a gap through which the insulating liquid material flows.

2. The input device according to claim 1,
wherein the region dividing member is provided entirely in the thickness direction between the first substrate and the second substrate.

3. The input device according to claim 1,
wherein the region dividing member is provided on at least one of the side of the insulating liquid material in contact with the first substrate and the side of the insulating liquid material in contact with the second substrate, and
the region dividing member is not provided partially in the thickness direction between the first substrate and the second substrate.

4. The input device according to claim 2,
wherein the region dividing member is formed of a reticulated polymer compound.

5. The input device according to claim 4,
wherein the region dividing member is a plurality of insulating protrusions which protrude from one of the first substrate side and the second substrate side toward the other side.

6. The input device according to claim 1,
wherein the first electrode is a resistance film which is provided on the surface of the first substrate opposite the second substrate, and
the second electrode is a resistance film which is provided on the surface of the second substrate opposite the first substrate.

7. An input function-equipped display device comprising:
a first substrate;
a flexible second substrate arranged opposite to the first substrate;
a first electrode for depression position detection provided on a surface of the first substrate opposite the second substrate or on the side of a first substrate opposite to the second substrate;
a second electrode for depression position detection provided on the second substrate;
an insulating liquid material filled between the first substrate and the second substrate; and
a region dividing member dividing a region where the insulating liquid material is filled between the first substrate and the second substrate into small sections with a gap through which the insulating liquid material flows; and
an image generating device provided on the side of the first substrate opposite to the second substrate in an overlapping manner.
